(19) United States
(12) Patent Application Publication
(10) Pub. No.: US 2011/0109084 A1
(43) Pub. Date: May 12, 2011

(54) PLASTIC SLIDING SLEEVE AND CONNECTING FITTING HAVING SUCH A SLIDING SLEEVE

(76) Inventors: Ehrenfried Bonhag, Schwabach (DE); Karl-Heinz Haunstetter, Furth (DE)

(21) Appl. No.: 13/000,629

(22) PCT Filed: Jun. 17, 2009
(86) PCT No.: PCT/EP09/04346

§ 371 Date: Dec. 22, 2010

(30) Foreign Application Priority Data
Jun. 30, 2008 (EP) 20 2008 008 554.3

(51) Int. Cl. F16L 21/00

(52) U.S. Cl. 285/417

(57) ABSTRACT

A plastic sliding sleeve (3) is used for sliding it onto a connecting piece (2) and for fixing a pipe end piece (5) in a clamping way to the connecting fitting in a clamping position. The sliding sleeve (3) comprises an inner wall (10) that can be applied at least in sections to an outer wall of the pipe end piece (5) in the clamping position. The inner wall (10) comprises at least one circumferential rib (13) which protrudes toward the inside over the remaining inner wall (10) and runs at least along a section of an inner circumference of the sliding sleeve (3). A sliding sleeve is obtained, with which an undesired relative movement between the sliding sleeve and the pipe end section is prevented.

The invention relates to a plastic sliding sleeve for a connecting piece in particular for a pressure-tight connection of a pipe to the connecting piece. The invention relates further to a connecting fitting having a connecting piece and such a sliding sleeve.

A plastic sleeve for a connecting piece for connecting pipes is known through prior public use. In case of the known connecting fitting, under extreme conditions, an undesired axial relative movement between the sliding sleeve on the one side and the press-fitted or clamped pipe end section on the other side takes place.

It is an object of the present invention to develop a plastic sliding sleeve of the aforementioned type in such a manner that such an undesired relative movement is avoided in practice.

This object is solved according to the invention by a plastic sliding sleeve with the features specified in the claim 1.

It was found according to the invention that a circumferential rib protruding from the inner diameter results in the desired protection against a relative movement of the sliding sleeve with respect to the pipe end section. The circumferential rib can penetrate into the outer wall of the pipe end piece. At the same time, such a circumferential rib allows the production of the sliding sleeve as injection molding component without the need of a complicated design of an injection molding tool because the circumferential rib can be formed in the region of a core parting plane of the injection molding tool which is necessary anyway. In this case, the injection mold remains free of undercuts.

This represents a significant production cost advantage in comparison to inner profiles of sliding sleeves having undercuts as they are known, for example, from DE 38 13 815 C2. Such a design of the injection molding tool in which the circumferential rib is generated by complementary chamfers on the front end regions of the mold halves opposing each other in the core parting plane can even result in an improved tool life of the injection molding tool because by chamfering the mold halves, an improved wear resistance of the front end wall of the mold halves is exhibited in the region of the core parting plane.

Cross-sectional shapes according to claim 2 can be manufactured cost-effectively.

An edge-free cross-sectional profile according to claim 3 facilitates sliding the sliding sleeve onto the pipe end piece.

Dividing the circumferential rib into sections according to claim 4 results in easing the sliding, in particular if the pipe onto which the sliding sleeve is slid does not have a perfectly round outer wall. By rotating the sliding sleeve on the pipe, a position can be found in which the circumferential rib sections face regions of the pipe which have a reduced diameter with respect to other circumferential regions. The circumferential rib sections can be present on the same axial height, but, in addition to the offset in the circumferential direction, can also be arranged axially offset to each other. Alternatively to the dividing into circumferential rib sections, a continuously extending circumferential rib in particular with a constant cross-section can be provided.

A continuous protrusion contour according to claim 5 prevents the sliding sleeve from getting caught during sliding in the region of circumferential steps on the outer wall of the pipe.

A constant protrusion according to claim 6 can be manufactured in a simple manner.

Surprisingly, it was found that small protrusions according to claim 7 are sufficient for generating the desired axial locking. In particular, the protrusion can be at most 150 μm, at most 100 μm, at most 80 μm or even at most 30 μm.

The advantages of a connecting fitting according to claim 8 correspond to the ones which were described above in reference to the sliding sleeve.

Exemplary embodiments of the invention are illustrated in more detail hereinafter by means of the drawing. In the figures:

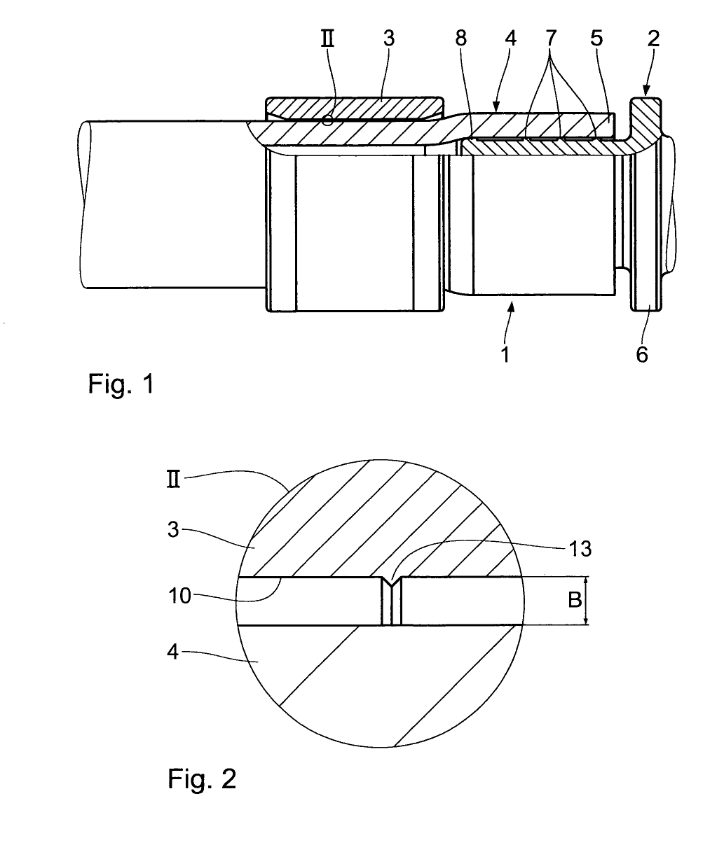

FIG. 1 shows a connecting fitting with a connecting piece and a plastic sliding sleeve in an initial position in which a hose end piece slid onto the connecting piece is still unclamped;

FIG. 2 shows an enlargement of detail II in FIG. 1;

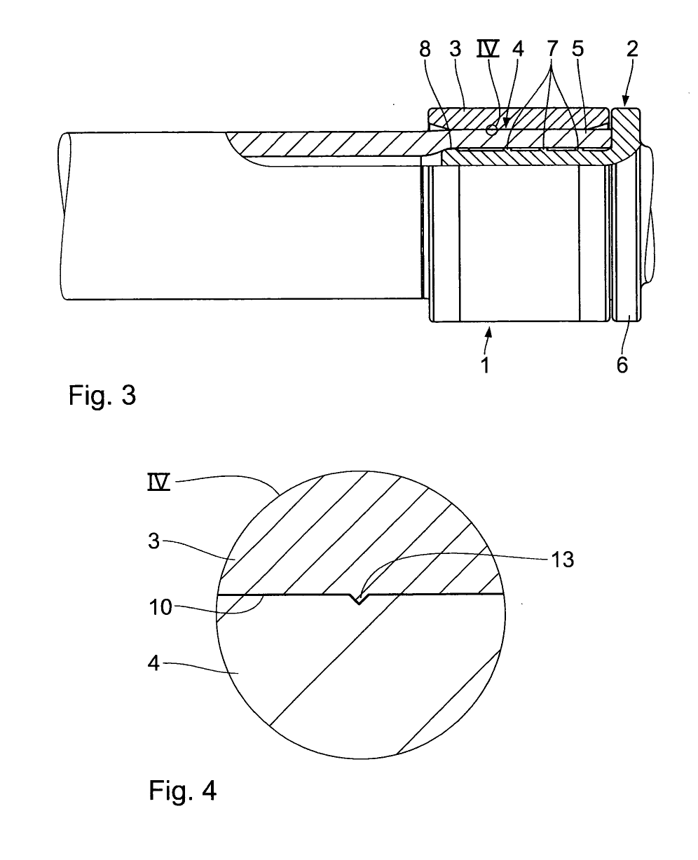

FIG. 3 shows the connecting fitting with the hose end piece of FIG. 1 with the sliding sleeve displaced with respect to the initial position into a clamping position;

FIG. 4 shows an enlargement of the detail IV in FIG. 3;

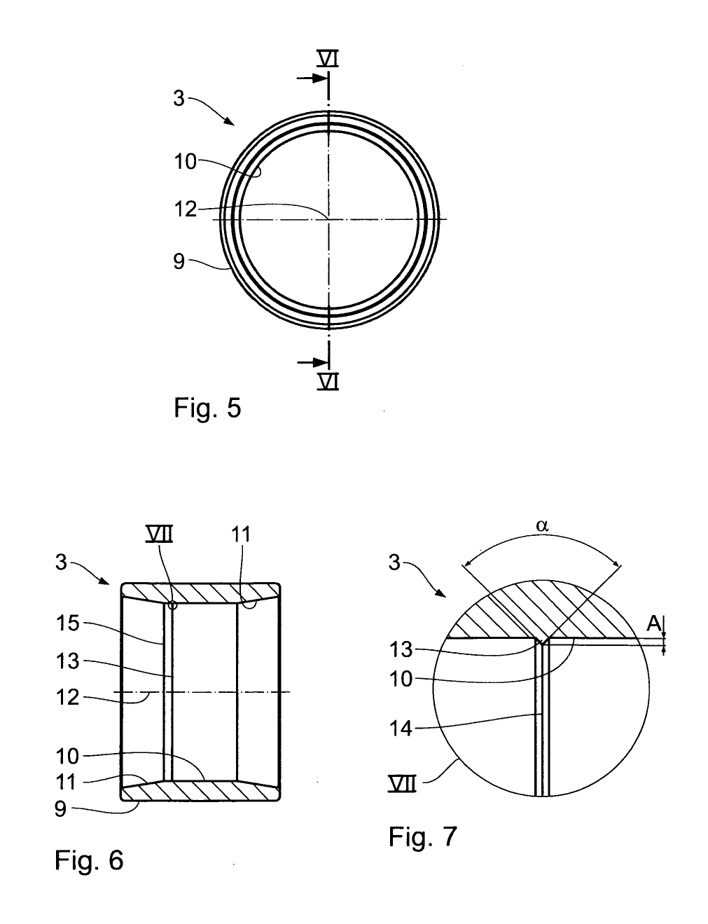

FIG. 5 shows a frontal view of the sliding sleeve;

FIG. 6 shows a section according to line VI-VI in FIG. 5;

FIG. 7 shows an enlargement of the detail VII in FIG. 6;

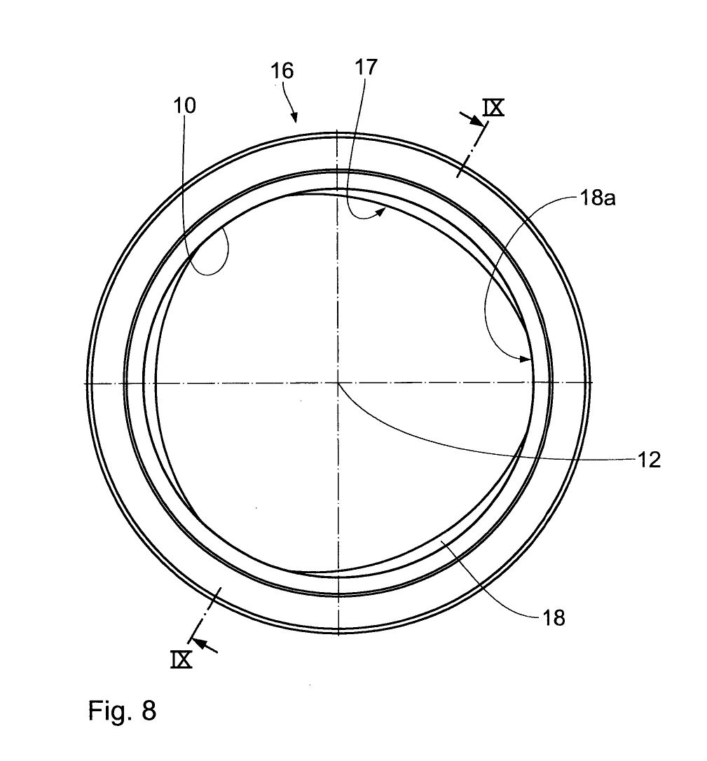

FIG. 8 shows a view similar to FIG. 5 of a further embodiment of a sliding sleeve for use with the connecting piece according to FIG. 1;

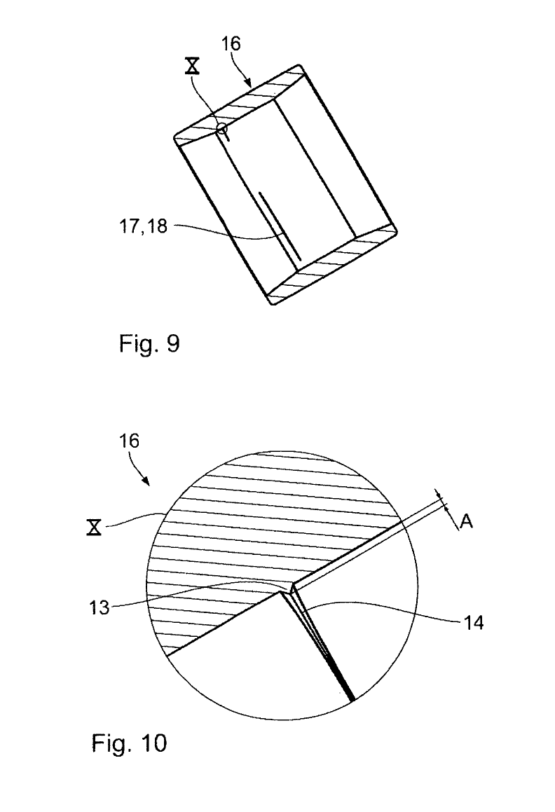

FIG. 9 shows a section according to line IX-IX in FIG. 8;

FIG. 10 shows an enlargement of the detail X in FIG. 9; and

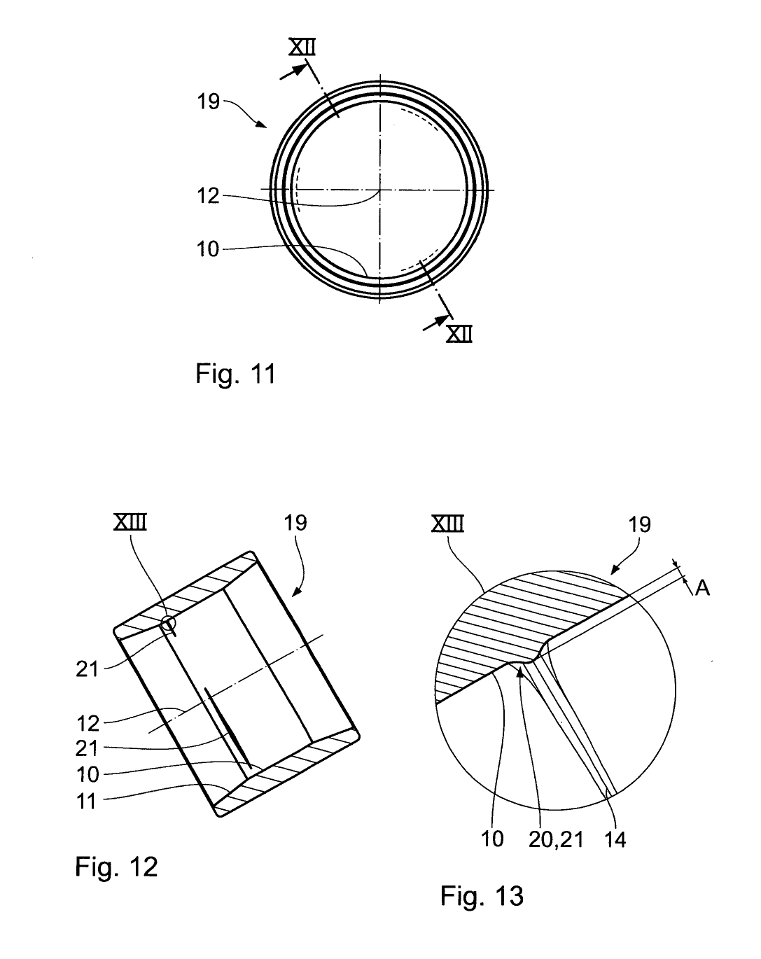

FIGS. 11 to 13 show illustrations similar to the FIGS. 8 to 10 of a further embodiment of a sliding sleeve for use with the connecting piece according to FIG. 1.

FIG. 1 shows a connecting fitting 1 with a connecting piece 2 and a sliding sleeve 3. The connecting fitting 1 ensures a secure and in particular, pressure-tight connection of a pipe 4 to the connecting piece 2. FIG. 1 shows the connecting fitting 1 in an initial position of the sliding sleeve in which a pipe end piece 5, which is slid onto the connecting piece 2, is still unclamped.

The sliding sleeve 3 is made of plastic. In the illustrated embodiment, the sliding sleeve 3 is made of polyvinylidene fluoride (PVDF). Another high-strength polymer material can also be used for forming the sliding sleeve 3. The connecting piece 2 can also be made of PVDF. In the illustrated preferred embodiment, the connecting piece 2 is made of polyphenylsulfone (PPSU). Alternatively, the connecting piece 2 can also be made of metal, for example, of brass or steel. The pipe 4 can involve in particular a reinforced plastic pipe or a metal-plastic composite pipe. Material examples for the pipe 4 are cross-linked polyethylene (PE-X) or polybutylene (PB).

The connecting piece 2 is shown in FIG. 2 in a partial section only to an extent that is necessary for the description of the pressure-tight pipe connection. In FIG. 1, to the right of a stop collar 6 which limits the sliding of the pipe 4 onto the connection piece 2, the connecting piece can merge, for example, into a further connecting piece for sliding a further pipe 4 onto it, or into a mounting extension, for example, a screw thread. Also, a 90° -corner connector or a T-piece is possible as an extended variant of the connecting piece 2.

On its outer circumferential wall, facing the inner wall of the slid-on pipe end piece 5, the connecting piece 2 has a plurality of circumferential ribs 7 which are axially spaced apart from each other. At its free end facing away from the stop collar 6, the outer circumference of the connecting piece 2 first increases in steps in an end region 8 and then extends conically tapered towards the end, which makes it easier to slide the pipe end piece onto the connecting piece 2.

The sliding sleeve 3 is illustrated in more detail in the FIGS. 5 to 7. The sliding sleeve 3 has a smooth cylindrical outer circumferential wall 9. An inner circumferential wall of the sliding sleeve 3 is axially divided in a middle section 10 and in conical sections 11 which expand in an axial direction towards the ends of the sliding sleeve 3.

Depending on the embodiment of the sliding sleeve 3, the extension of the conical sections 11 along a longitudinal axis 12 of the sliding sleeve 3 (which axis represents, at the same time, a rotational axis of symmetry of the sliding sleeve) can vary. Also, the cone angle of the conical sections 11 can be different in different embodiments of the sliding sleeve 3.

The middle section 10 of the inner wall of the sliding sleeve 3 has a circumferential rib 13 which protrudes over the remaining inner wall towards the inside, thus towards the longitudinal axis 12. In the embodiment according to FIGS. 1 to 7, the circumferential rib 13 runs over the entire inner circumference of the sliding sleeve 3. The circumferential rib 13 has a constant triangular cross-section in the circumferential direction (see FIG. 7). An apex angle a of the circumferential rib 13 is 90° . Other apex angles are also possible. A protrusion A of the circumferential rib 13 over the middle section 10 of the inner wall of the sliding sleeve 3 is 70 μm.

The circumferential rib 13 has a constant protrusion A in the circumferential direction over the middle section 10 of the inner wall of the sliding sleeve 3.

The sliding sleeve 3 is a plastic injection molded component. In FIG. 7, a core parting plane 14 is indicated which reflects the partition of two mold halves of an undercut-free injection mold for manufacturing the sliding sleeve 3 by injection molding. The circumferential apex of the circumferential rib 13 runs within the core parting plane 14.

With respect to its axial position along the longitudinal axis 12, the circumferential rib 13 does not run at the central position of the middle section 10 of the inner wall of the sliding sleeve 3, but off-center near a transition 15 between the middle section 10 and the conical section 11 on the left in FIG. 6. A central arrangement of the circumferential rib 13 is also possible.

The enlarged detail according to FIG. 2 shows that in the initial position, play B is present between the circumferential rib 13 and the remaining middle section 10 of the sliding sleeve on the one side and the pipe 4 on the other side, which play is many times greater than the protrusion A. Said play between the sliding sleeve 3 and the pipe 4 lies precisely where the pipe 4 is not slid onto the connecting piece 2.

FIGS. 3 and 4 show a clamping position of the connecting fitting 1. The sliding sleeve 3 is slid from the initial position according to FIG. 1 to the right onto the connecting piece 2 by means of an adequate tool.

A radial distance between the sliding sleeve 3 and the connecting piece 2 is smaller than a wall thickness of the pipe end piece 5 so that the latter is clamped or press-fitted between the connecting piece 2 and the sliding sleeve 3. Here, the circumferential rib 13 penetrates (see FIG. 4) into outer wall of the pipe end piece 5. Thus, the circumferential rib 13 together with the circumferential ribs 7 and the circumferentially enlarged end region 8 of the connecting piece 2 secure the pipe end piece 5 against an axial displacement relative to the connecting fitting 1 on the one side and relative to the sliding sleeve 3 on the other side.

As an alternative to the triangular cross-section, the circumferential rib 13 can also have another cross-sectional shape, for example a rectangular cross-section or an edge-free cross-section.

The connecting fitting 1 is designed for a pipe 4 with the nominal width 40 mm. Alternative configurations for other nominal widths differ from the described structure merely in their dimensions and, if necessary, in the ratio of the axial extensions of the middle section 10 to the conical sections 11 of the inner wall.

FIGS. 8 to 10 show a further embodiment of a sliding sleeve 16 which can be used instead of the sliding sleeve 3 with the connecting fitting 1 according to the FIGS. 1 to 7. Components which correspond to the ones already described above with reference to the FIGS. 1 to 7 are designated with the same reference numbers and will not be discussed again in detail.

The sliding sleeve 16 has a circumferential rib 17 which, with respect to its radial extension, is illustrated greatly enlarged and not to scale.

The circumferential rib 17 is divided into three circumferential rib sections 18. Each circumferential rib section 18 covers a circumferential angle of 90° about the longitudinal axis 12. Between the circumferential rib sections 18 there is in each case one rib-free circumferential section 18a having a circumferential extension of 30° . Thus, the three circumferential rib sections 18 are offset to each in the circumferential direction and are at the same height in the axial direction. In a non- illustrated embodiment, the circumferential rib sections 18 can also be arranged offset to each other in the axial direction.

In the circumferential direction about the longitudinal axis 12, the circumferential rib sections 18 have a continuously running protrusion over the middle section 10 of the inner wall of the sliding sleeve 16. Viewed in the circumferential direction from the respective middle of a circumferential rib section 18, this protrusion, starting at a central maximum of the protrusion with a protrusion of, for example, 80 μm, decreases continuously in the circumferential direction towards the edges of the circumferential sections 18 until it reaches zero.

The circumferential rib sections 18 are generated during injection molding in correspondingly complementarily shaped intermediate spaces between the mold halves in the region of the core parting plane 14. Said intermediate spaces are shaped by obliquely chamfering the mold halves' front walls that oppose each other in the core parting plane 14.

Dividing the circumferential rib 17 into the circumferential rib sections 18 makes it easier to slide the sliding sleeve 16 onto the pipe 4, in particular if the pipe 4 is not perfectly round with respect to its outer cross-section.

Instead of three circumferential rib sections 18 it is also possible to provide two, four, five or even more circumferential ribs sections.

A different protrusion of the circumferential rib sections 18 over the middle section 10 of the inner wall of the sliding sleeve 16 is also possible, for example, a protrusion of 30 μm.

In a non-illustrated embodiment and alternatively to the configuration of the circumferential rib sections 18 according to the FIGS. 8 to 10, the latter have, in the circumferential direction and about the longitudinal axis 12, a constant protrusion over the middle section 10 of the inner wall of the sliding sleeve 16. Precisely at each point where the circumferential rib sections 18 merge into the rib-free sections 18, a step in the circumferential direction is thus present.

FIGS. 11 to 13 show a further variant of a sliding sleeve 19. Components which correspond to the ones described above with reference to the FIGS. 1 to 10 are designated with the same reference numbers and will not be discussed again in detail.

The sliding sleeve 19 comprises a circumferential rib 20 which, corresponding to the circumferential rib 17 of the embodiment according to the FIGS. 8 to 10, is also divided into three circumferential rib sections 21. In contrast to the triangular cross-section of the circumferential rib sections 21 having an apex angle of 90° , the circumferential rib sections 21 have a cross-section formed free of edges so that the circumferential rib 20 is shaped as circumferential bead. This cross-sectional profile is generated by a correspondingly complementary configuration of the mold halves in the region of the core parting plane 14. The edge-free cross-section of the circumferential rib 20 facilitates again the sliding of the sliding sleeve 19 onto the pipe 4.

The maximum protrusion A of the circumferential rib sections 21 over the middle section 10 of the sliding sleeve 19 of the embodiment according to the FIGS. 11 to 13 is 150 μm.

1. A plastic sliding sleeve (3; 16; 19) for sliding the same onto a connecting piece (2) and for clampingly fixing a pipe end piece (5) to the connecting piece (2) in a clamping position
having an inner wall (10, 11) which, in the clamping position, can be applied at least in sections to an outer wall of the pipe end piece (5),
wherein the inner wall (10, 11) has at least one circumferential rib (13; 17; 20) which protrudes inwardly and over the remaining inner wall and which runs at least along one section of an inner circumference of the sliding sleeve (3; 16;
19).

2. The sliding sleeve according to claim 1, wherein the circumferential rib (13; 17) has a triangular or a rectangular cross-section.

3. The sliding sleeve according to claim 1, wherein the circumferential rib (20) has a cross-section extending free of edges.

4. The sliding sleeve according to claim 1, wherein the circumferential rib (17; 20) is divided into a plurality of circumferential rib sections (18; 21), in particular in more than two, preferably three circumferential rib sections which are arranged offset to each other in the circumferential direction.

5. The sliding sleeve according to claim 4, wherein in the circumferential direction, the circumferential rib sections (18; 21) have a continuously running protrusion over the inner wall (10, 11).

6. The sliding sleeve according to claim 4, wherein in the circumferential direction, the circumferential rib sections (18; 21) have a constant protrusion over the inner wall (10, 11).

7. The sliding sleeve according to claim 1, wherein the maximum protrusion of the circumferential rib (13; 17; 20) over the inner wall (10, 11) of the sliding sleeve (3; 16; 19) is not more than 200 μm.

8. A connecting fitting (1)
having a connecting piece (2) onto which a pipe (4) can be slid,
having a sliding sleeve according to claim 1 for sliding the same onto the connecting piece (2) and for clampingly fixing a pipe end piece (5) to the connecting piece (2) in a clamping position.

9. The sliding sleeve according to claim 2, wherein the circumferential rib (17; 20) is divided into a plurality of circumferential rib sections (18; 21) which arc arranged offset to each other in the circumferential direction.

10. The sliding sleeve according to claim 3, wherein the circumferential rib (17; 20) is divided into a plurality of circumferential rib sections (18; 21) which are arranged offset to each other in the circumferential direction.

11. The sliding sleeve according to claim 2, wherein the maximum protrusion of the circumferential rib (13; 17; 20) over the inner wall (10, 11) of the sliding sleeve (3; 16; 19) is not more than 200 μm.

12. The sliding sleeve according to claim 3, wherein the maximum protrusion of the circumferential rib (13; 17; 20) over the inner wall (10, 11) of the sliding sleeve (3; 16; 19) is not more than 200 μm.

13. The sliding sleeve according to claim 4, wherein the maximum protrusion of the circumferential rib (13; 17; 20) over the inner wall (10, 11) of the sliding sleeve (3; 16; 19) is not more than 200 μm.

14. The sliding sleeve according to claim 5, wherein the maximum protrusion of the circumferential rib (13; 17; 20) over the inner wall (10, 11) of the sliding sleeve (3; 16; 19) is not more than 200 μm.

15. The sliding sleeve according to claim 6, wherein the maximum protrusion of the circumferential rib (1.3; 17; 20) over the inner wall (10, 11) of the sliding sleeve (3; 1.6; 19) is not more than 200 μm.

16. A connecting fitting (1) having a connecting piece (2) onto which a pipe (4) can be slid, having a sliding sleeve according to claim 2 for sliding the same onto the connecting piece (2) and for clampingly fixing a pipe end piece (5) to the connecting piece (2) in a clamping position.

17. A connecting fitting (1) having a connecting piece (2) onto which a pipe (4) can be slid, a sliding, sleeve according to claim 3 for sliding the same onto the connecting piece (2) and for clampingly fixing a pipe end piece (5) to the connecting piece (2) in a clamping position.

18. A connecting fitting (1) having a connecting piece (2) onto which a pipe (4) can be slid, a sliding sleeve according to claim 4 for sliding the same onto the connecting piece (2) and for clampingly fixing a pipe end piece (5) to the connecting piece (2) in a clamping position.

19. A connecting fitting (1) having a connecting piece (2) onto which a pipe (4) can be slid, a sliding sleeve according to claim 5 for sliding the same onto the connecting piece (2) and for clampingly fixing a pipe end piece (5) to the connecting piece (2) in a clamping position.

20. A connecting fitting (1) having a connecting piece (2) onto which a pipe (4) can be slid, a sliding sleeve according to claim 6 for sliding the same onto the connecting piece (2) and for clampingly fixing a pipe end piece (5) to the connecting piece (2) in a clamping position.
